(19) United States
(12) Patent Application Publication
(10) Pub. No.: US 2014/0120933 A1
(43) Pub. Date: May 1, 2014

(54) WIRELESS COMMUNICATION APPARATUS, WIRELESS COMMUNICATION SYSTEM, AND WIRELESS COMMUNICATION METHOD

(71) Applicant: FUJITSU LIMITED, Kawasaki-shi (JP)

(72) Inventors: Dai KIMURA, Yokohama (JP); Yuya Harada, Kawasaki (JP)

(73) Assignee: FUJITSU LIMITED, Kawasaki-shi (JP)

(21) Appl. No.: 14/061,356

(22) Filed: Oct. 23, 2013

(30) Foreign Application Priority Data
Oct. 25, 2012 (JP) 2012-235559

(51) Int. Cl. H04W 72/08

(52) U.S. Cl. CPC H04W 72/082
USPC 455/452.1

(57) ABSTRACT

A wireless communication apparatus, includes: a processor configured to: perform a first detection to detect another wireless communication apparatus that shares given frequency bands with the wireless communication apparatus and that causes interference with the wireless communication apparatus, perform a second detection to detect a second wireless terminal that has communication quality lower than or equal to a given value from a first wireless terminal that communicates with the wireless communication apparatus, and select a frequency band from the given frequency bands for communication with the first wireless terminal based on a combination of detection result of the first detection and the second detection; and a transmitter coupled to the processor and configured to transmit a signal to the first wireless terminal using the selected frequency band.

### CROSS-REFERENCE TO RELATED APPLICATION

This application is based upon and claims the benefit of priority of the prior Japanese Patent Application No. 2012-235559, filed on Oct. 25, 2012, the entire contents of which are incorporated herein by reference.

### FIELD

The embodiments discussed herein are related to a wireless communication apparatus, a wireless communication circuit, a wireless communication system, and a wireless communication method.

### BACKGROUND

A femto base station (Home eNB: HeNB), also referred to as low power base station, is often installed in a personal residence or the like to extend indoors coverage of a cellular network, such as Universal Mobile Telecommunication System (UMTS). A coverage area of a femto base station is commonly referred to as a femto cell, a low power cell or a small cell. In the femto base station, for example, access restriction is implemented so that users other than a registered user are restricted from connecting to the femto base station.

When using a femto base station, for example, a user who is close to the femto base station but is not able to connect to the femto base station may receive interference from the femto base station, so that the throughput may be degraded or the connection may be disconnected. To cope with this, a method is known in which transmission power from the femto base station is reduced when such a user is detected (for example, see Japanese Laid-open Patent Publication No. 2010-283826).

When two femto base stations are close to each other, the femto base stations may interfere with each other, so that the throughput may be degraded. To cope with this, a method is known in which the femto base station performs bandwidth control (for example, see Japanese Laid-open Patent Publication No. 2010-103753).

### SUMMARY

According to an aspect of the invention, a wireless communication apparatus, includes: a processor configured to: perform a first detection to detect another wireless communication apparatus that shares given frequency bands with the wireless communication apparatus and that causes interference with the wireless communication apparatus, perform a second detection to detect a second wireless terminal that has communication quality lower than or equal to a given value from a first wireless terminal that communicates with the wireless communication apparatus, and select a frequency band from the given frequency bands for communication with the first wireless terminal based on a combination of detection result of the first detection and the second detection; and a transmitter coupled to the processor and configured to transmit a signal to the first wireless terminal using the selected frequency band.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication system according to a first embodiment;

FIG. 2A is a diagram illustrating an example of a base station;

FIG. 2B is a diagram illustrating an example of a signal flow in the base station illustrated in FIG. 2A;

FIG. 2C is a diagram illustrating an example of a hardware configuration of the base station;

FIG. 3 is a flowchart illustrating an example of an operation of a transmission pattern candidate extraction unit and a transmission pattern determination unit;

FIG. 4A is a diagram illustrating an example of a candidate of a transmission pattern (No. 1);

FIG. 4B is a diagram illustrating an example of a candidate of the transmission pattern (No. 2);

FIG. 4C is a diagram illustrating an example of a candidate of the transmission pattern (No. 3);

FIG. 5 is a diagram illustrating an example of a transmission pattern table;

FIG. 6A is a diagram illustrating an example of an operation of a communication system (No. 1);

FIG. 6B is a diagram illustrating an example of an operation of the communication system (No. 2);

FIG. 6C is a diagram illustrating an example of an operation of the communication system (No. 3);

FIG. 6D is a diagram illustrating an example of an operation of the communication system (No. 4);

FIG. 7A is a diagram illustrating an example of a transmission pattern (No. 1);

FIG. 7B is a diagram illustrating an example of a transmission pattern (No. 2);

FIG. 7C is a diagram illustrating an example of a transmission pattern (No. 3);

FIG. 7D is a diagram illustrating an example of a transmission pattern (No. 4);

FIG. 7E is a diagram illustrating an example of a transmission pattern (No. 5);

FIG. 7F is a diagram illustrating an example of a transmission pattern (No. 6);

FIG. 8 is a diagram illustrating an example of a transmission pattern table;

FIG. 9 is a diagram illustrating an example of a communication system according to a third embodiment;

FIG. 10A is a diagram illustrating an example of a base station;

FIG. 10B is a diagram illustrating an example of a signal flow in the base station illustrated in FIG. 10A;

FIG. 11 is a flowchart illustrating an example of an operation of a transmission pattern candidate extraction unit and a transmission pattern determination unit;

FIG. 12 is a diagram illustrating an example of a transmission pattern table;

FIG. 13 is a diagram illustrating an example of an operation of a communication system;

FIG. 14A is a diagram illustrating a modified example of a candidate of the transmission pattern (No. 1);

FIG. 14B is a diagram illustrating a modified example of a candidate of the transmission pattern (No. 2); and

FIG. 14C is a diagram illustrating a modified example of a candidate of the transmission pattern (No. 3).

### DESCRIPTION OF EMBODIMENTS

Hereinafter, embodiments of to a base station, a communication system, and a communication method will be described in detail with reference to the drawings.

While inventing the present embodiments, observations were made regarding a related art. Such observations include the following, for example.

In a communication system of the related art, there is a case in which the throughput of a user terminal that receives interference from a femto base station or the like and a user terminal connected to the femto base station or the like is difficult to be improved.

Therefore, the embodiments disclosed herein, for example, provide wireless communication apparatus, a wireless communication circuit, a wireless communication system, and a wireless communication method that may improve the throughput. The wireless communication apparatus includes a base station, for example.

### First Embodiment

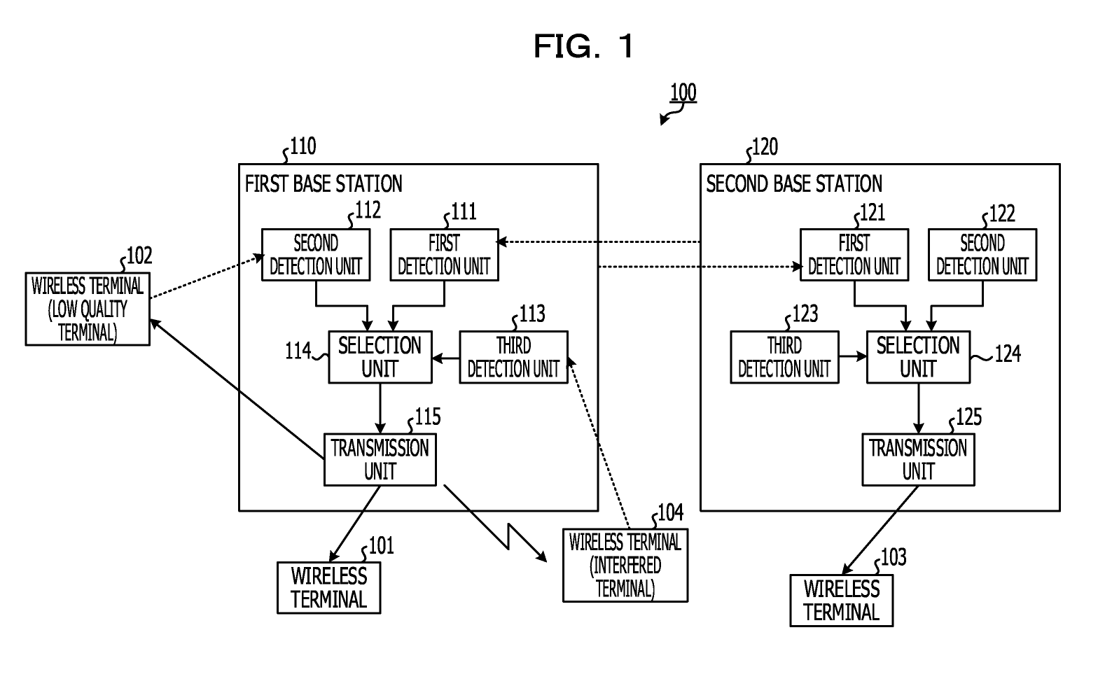

FIG. 1 is a diagram illustrating an example of a communication system according to a first embodiment. As illustrated in FIG. 1, the communication system 100 according to the first embodiment includes a first base station 110, a second base station 120, and wireless terminals 101 to 104.

The first base station 110 and the second base station 120 can use given frequency bands (hereinafter referred to as the “common frequency band”) in each cell thereof and form cells adjacent to each other. In other words, the first base station 110 and the second base station 120 form cells which may interfere with each other. Each of the first base station 110 and the second base station 120 is, for example, a Home eNodeB (HeNB) that forms a femto cell.

The wireless terminals 101 and 102 are wireless terminals that are connected to the cell of the first base station 110. The wireless terminal 102 is a low quality terminal whose communication quality with the first base station 110 is lower than or equal to a given value because of the reasons that the distance between the wireless terminal 102 and the first base station 110 is long or the wireless terminal 102 receives interference from the second base station 120 because the distance from the second base station 120 is short.

The wireless terminal 103 is a wireless terminal that is connected to the cell of the second base station 120. Although the wireless terminal 104 is connected to none of the first base station 110 and the second base station 120, the wireless terminal 104 is located close to the first base station 110 and is an interfered terminal (also referred to herein as a victim terminal) which is interfered by transmission signals from the first base station 110 to the wireless terminals 101 and 102. Each of the wireless terminals 101 to 104 is, for example, a user equipment (UE).

The first base station 110 wirelessly transmits a downlink signal to the wireless terminals 101 and 102 that are connected to the cell of the first base station 110. Specifically, the first base station includes first detection unit 111, second detection unit 112, third detection unit 113, a selection unit 114, and a transmission unit 115.

The first detection unit 111 detects presence or absence of an adjacent base station that is performing communication among adjacent base stations such as the second base station 120. For example, the first detection unit 111 detects presence or absence of an adjacent base station that is performing communication based on a signal transmitted from adjacent base stations. The first detection unit 111 outputs the detection result to the selection unit 114.

The second detection unit 112 detects presence or absence of a low quality terminal such as the wireless terminal 102. For example, the second detection unit 112 detects a low quality terminal based on communication quality notified from wireless terminals connected to the first base station 110. The second detection unit 112 outputs the detection result to the selection unit 114.

The third detection unit 113 detects presence or absence of an interfered terminal such as the wireless terminal 104. For example, the third detection unit 113 measures radio frequency (RF) power of an uplink signal transmitted from wireless terminals connected to other cells and detects presence or absence of an interfered terminal based on the measurement result. The third detection unit 113 outputs the detection result to the selection unit 114.

The selection unit 114 selects a frequency band used for the first base station 110 to transmit a downlink signal from the common frequency band based on a combination of the detection results outputted from the first detection unit 111, the second detection unit 112, and the third detection unit 113. Then, the selection unit 114 notifies the transmission unit 115 of the selected frequency band.

For example, the selection unit 114 extracts candidates of the frequency band corresponding to the combination of the detection results based on correspondence information between the combination of the detection results and candidates of the frequency band included in the common frequency band. Then the selection unit 114 calculates the throughput between the base station 110 and the wireless terminals (for example, the wireless terminals 101 and 102) that are connected to the cell of the base station 110 for each of the extracted candidates of the frequency band and selects the frequency band from the extracted candidates of the frequency band based on the calculated throughputs. Thereby, it is possible to select a frequency band in which the throughput is most improved from the candidates of the frequency band corresponding to the combination of the detection results.

The transmission unit 115 wirelessly transmits a downlink signal to the wireless terminals 101 and 102 that are connected to the cell of the first base station 110 by using the frequency band notified by the selection unit 114. However, the transmission unit 115 does not have to use all of the frequency band notified by the selection unit 114, but may use a part of the frequency band notified by the selection unit 114.

The second base station includes first detection unit 121, second detection unit 122, third detection unit 123, a selection unit 124, and a transmission unit 125. The configurations of first detection unit 121, the second detection unit 122, the third detection unit 123, the selection unit 124, and the transmission unit 125 of the second base station 120 are the same as those of the first detection unit 111, the second detection unit 112, the third detection unit 113, the selection unit 114, and the transmission unit 115 of the second base station 110, respectively.

In the example illustrated in FIG. 1, the first detection unit 121 of the second base station 120 detects the first base station 110 as an adjacent base station. There is no low quality terminal that is connected to the second base station 120, so that the second detection unit 122 does not detect a low quality terminal. There is no interfered terminal that receives interference from the second base station 120 around the second base station 120, so that the third detection unit 123 does not detect an interfered terminal.

For example, when an adjacent base station is detected by the first detection unit 111 and a low quality terminal is detected by the second detection unit 112, the selection unit 114 of the first base station 110 selects a part of the common frequency band. Thereby, in the example illustrated in FIG. 1, the second base station 120 is detected as an adjacent base station by the first detection unit 111 and the wireless terminal 102 is detected as a low quality terminal by the second detection unit 112, so that a part of the common frequency band is selected by the selection unit 114. Therefore, the transmission unit 115 transmits a downlink signal to the wireless terminals 101 and 102 by using a part of the common frequency band.

Thereby, the first base station 110 urges the second base station to use a frequency band that is not used by the first base station 110 in the common frequency band, so that it is possible to reduce the interference from the second base station 120 to the wireless terminal 102.

When an interfered terminal is detected by the third detection unit 113, even if at least either one of an adjacent base station and a low quality terminal is not detected, the selection unit 114 of the first base station 110 may select a part of the common frequency band. Thereby, in the example illustrated in FIG. 1, the wireless terminal 104 is detected as an interfered terminal by the third detection unit 113, so that the transmission unit 115 transmits a downlink signal to the wireless terminals 101 and 102 by using a part of the common frequency band.

Thereby, the first base station 110 urges the wireless terminal 104 to use a frequency band that is not used by the first base station 110 in the common frequency band, so that it is possible to reduce the interference from the first base station 110 to the wireless terminal 104.

In this way, in the communication system 100, the first base station 110 and the second base station 120 adjacent to each other autonomously control the transmission frequency band according to the combination of the detection results of the victim UE by the cell thereof, the low quality UE of the cell thereof, and the adjacent base station. Thereby, it is possible to improve the throughput of the victim UE and the low quality UE and improve the throughput of the entire communication system 100.

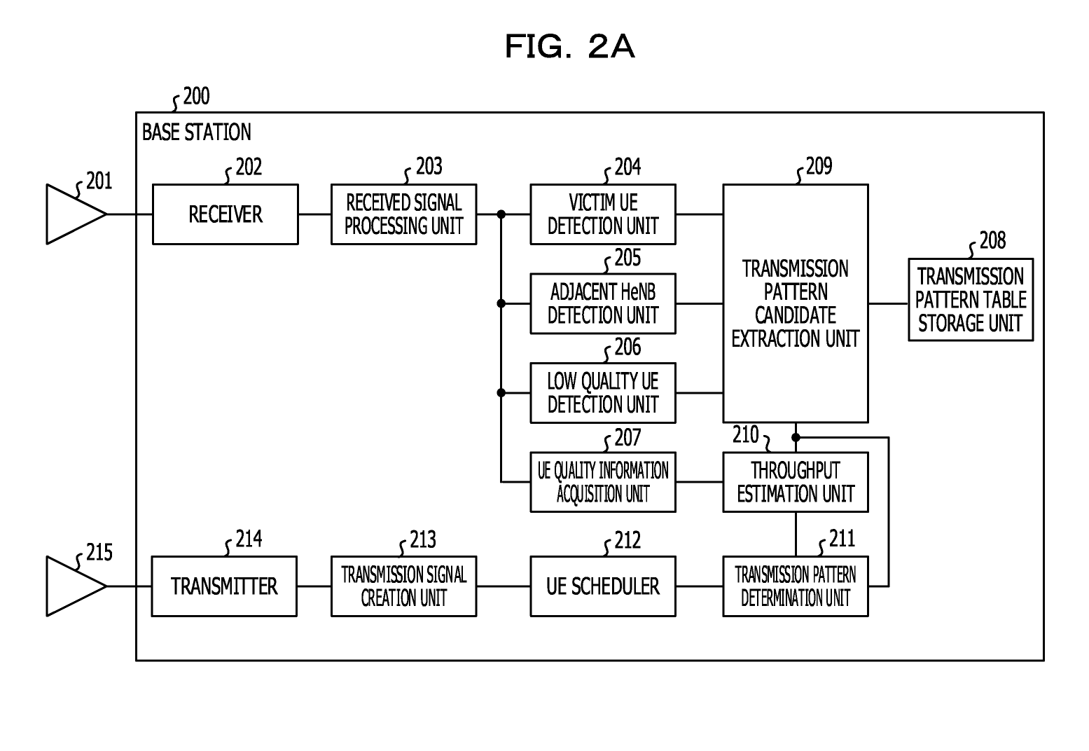

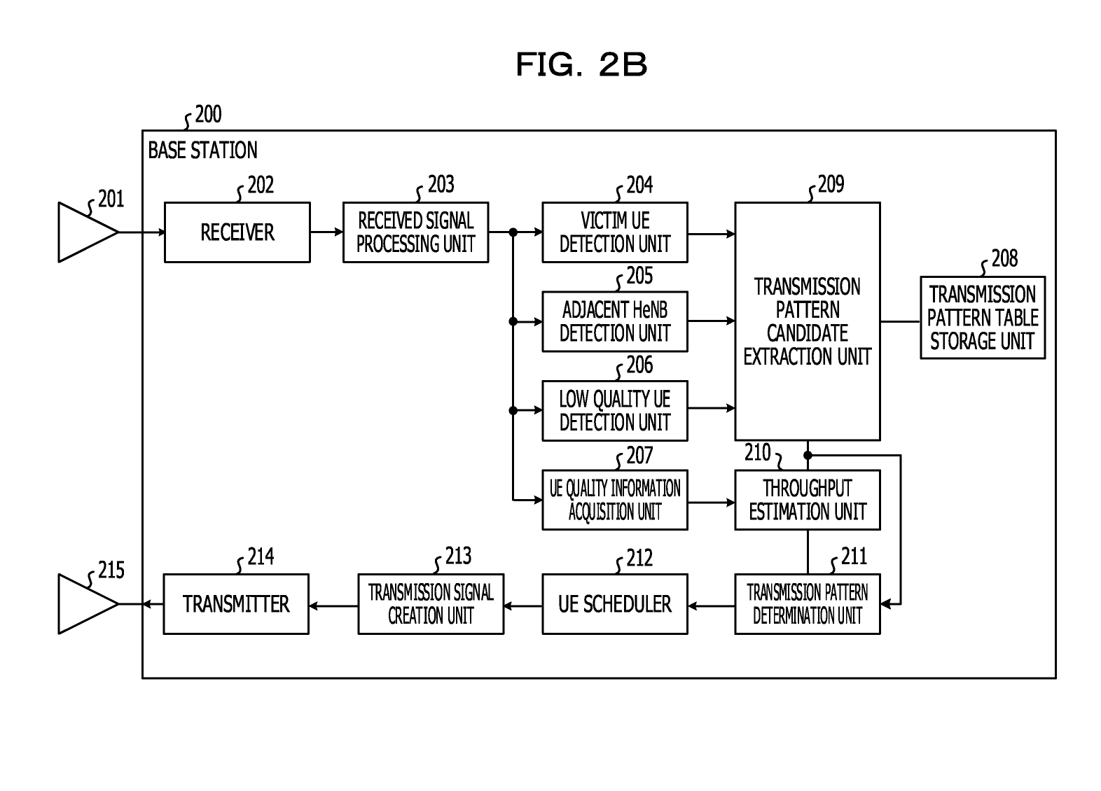

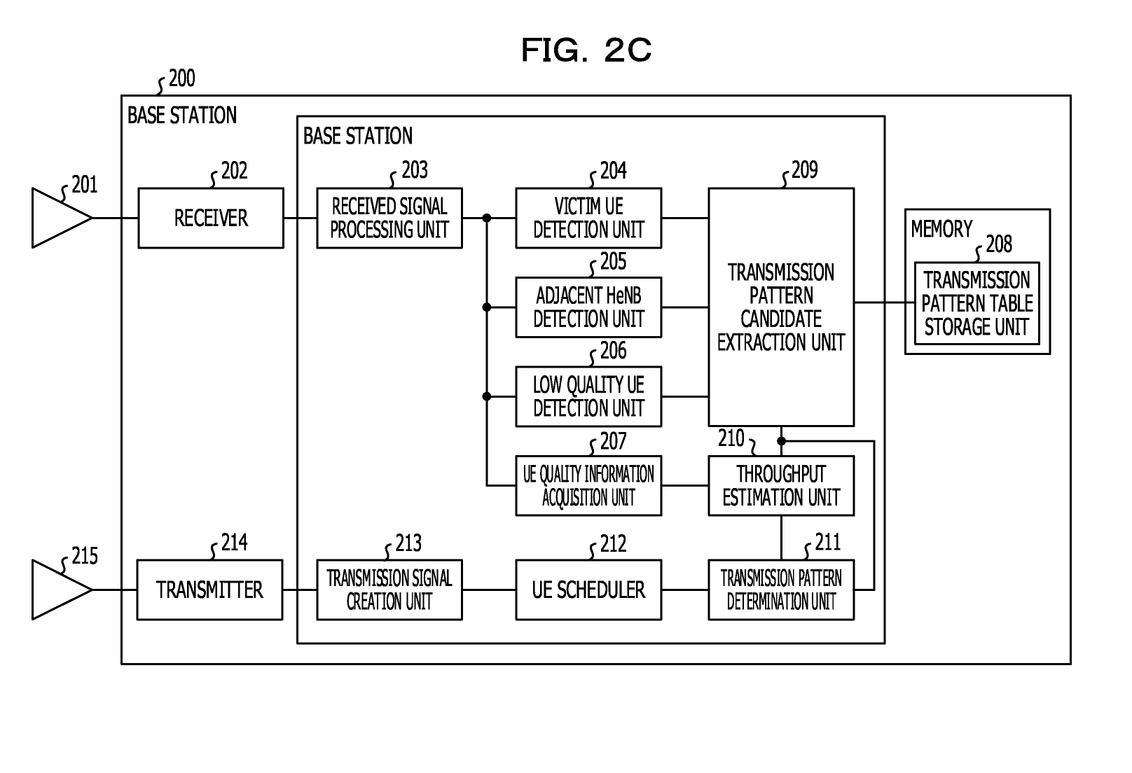

FIG. 2A is a diagram illustrating an example of a base station. FIG. 2B is a diagram illustrating an example of a signal flow in the base station illustrated in FIG. 2A. Each of the first base station 110 and the second base station 120 illustrated in FIG. 1 can be realized by, for example, the base station 200 illustrated in FIGS. 2A and 2B. The base station 200 can be applied to, for example, HeNB based on the standard of Long Term Evolution (LTE).

The base station 200 includes a receiving antenna 201, a receiver 202, a received signal processing unit 203, a victim UE detection unit 204, an adjacent HeNB detection unit 205, a low quality UE detection unit 206, a UE quality information acquisition unit 207, and a transmission pattern table storage unit 208. The base station 200 further includes a transmission pattern candidate extraction unit 209, a throughput estimation unit 210, a transmission pattern determination unit 211, a UE scheduler 212, a transmission signal creation unit 213, a transmitter 214, and a transmission antenna 215.

Each of the first detection units 111 and 121 illustrated in FIG. 1 can be realized by, for example, the receiving antenna 201, the receiver 202, the received signal processing unit 203, and the adjacent HeNB detection unit 205. Each of the second detection units 112 and 122 illustrated in FIG. 1 can be realized by, for example, the receiving antenna 201, the receiver 202, the received signal processing unit 203, and the low quality UE detection unit 206. Each of the third detection units 113 and 123 illustrated in FIG. 1 can be realized by, for example, the receiving antenna 201, the receiver 202, the received signal processing unit 203, and the victim UE detection unit 204.

Each of the selection units 114 and 124 illustrated in FIG. 1 can be realized by, for example, the transmission pattern table storage unit 208, the transmission pattern candidate extraction unit 209, the throughput estimation unit 210, and the transmission pattern determination unit 211. Each of the transmission units 115 and 125 illustrated in FIG. 1 can be realized by, for example, the UE scheduler 212, the transmission signal creation unit 213, the transmitter 214, and the transmission antenna 215.

The receiver 202 receives a signal wirelessly transmitted from another wireless communication apparatus (for example, a wireless terminal or another base station) through the receiving antenna 201. Then, the receiver 202 outputs the received signal to the received signal processing unit 203.

The received signal processing unit 203 performs channel estimation and received signal processing such as decoding on the signal outputted from the receiver 202. Then, the received signal processing unit 203 outputs the signal obtained by the received signal processing to the victim UE detection unit 204, the adjacent HeNB detection unit 205, the low quality UE detection unit 206, and the UE quality information acquisition unit 207.

The victim UE detection unit 204 detects a victim UE (an interfered terminal), which is not connected to the cell of the base station 200 and receives interference of a signal transmitted from the base station 200, based on the signal outputted from the received signal processing unit 203. For example, the victim UE detection unit 204 measures electric power of an uplink signal transmitted from UE connected to another cell and if the measurement result is greater than or equal to a certain value, the victim UE detection unit 204 determines that there is a victim UE.

The electric power of an uplink signal transmitted from UE connected to another cell can be measured by, for example, detecting a signal of a known pattern of the uplink signal transmitted from the UE connected to the other cell and measuring electric power of the detected signal. Or, the electric power of an uplink signal transmitted from UE connected to another cell can be measured based on interference power to an uplink signal received from UE that is connected to the base station 200. The victim UE detection unit 204 outputs the detection result of the victim UE to the transmission pattern candidate extraction unit 209.

The adjacent HeNB detection unit 205 detects an adjacent HeNB that forms an adjacent cell which can share a common frequency band with the cell of the base station 200 and generates interference between the adjacent cell and the cell of the base station 200, based on the signal outputted from the received signal processing unit 203. For example, the for cell search can detect an adjacent HeNB by measuring electric power of a downlink signal transmitted from the adjacent HeNB for cell search in the adjacent cell. The for cell search outputs the detection result of the adjacent HeNB to the transmission pattern candidate extraction unit 209.

The low quality UE detection unit 206 detects a low quality UE (a low quality terminal), which is connected to the cell of the base station 200 and whose communication quality is lower than or equal to a given value, based on the signal outputted from the received signal processing unit 203. For example, the low quality UE detection unit 206 acquires CQI (Channel Quality Indicator: channel quality information), which is transmitted from UE in the cell of the base station 200 and which indicates a downlink communication quality of the UE in the cell of the base station 200, and calculates an average of the acquired CQIs in a certain period of time. When the calculated average of the CQIs is smaller than or equal to a certain value, the low quality UE detection unit 206 determines that the UE that transmits the CQIs is a low quality UE. The low quality UE detection unit 206 outputs the detection result of the low quality UE to the transmission pattern candidate extraction unit 209.

The UE quality information acquisition unit 207 acquires quality information, which indicates downlink communication quality of each UE that is connected to the cell of the base station 200, based on the signal outputted from the received signal processing unit 203. For example, the UE quality information acquisition unit 207 acquires CQI for each frequency band transmitted from UE in the cell of the base station 200 as the quality information. Then, the UE quality information acquisition unit 207 outputs the acquired quality information to the throughput estimation unit 210.

The transmission pattern table storage unit 208 stores a transmission pattern table (correspondence information) that associates a combination of the detection results of the victim UE detection unit 204, the adjacent HeNB detection unit 205, and the low quality UE detection unit 206 with candidates of transmission pattern. The transmission pattern is information that indicates a frequency band used for the base station 200 to transmit a signal to UE. In the transmission pattern table, one or a plurality of candidates of transmission pattern are associated with each combination of the detection results.

The transmission pattern candidate extraction unit 209 acquires the detection results of the victim UE detection unit 204, the adjacent HeNB detection unit 205, and the low quality UE detection unit 206. Further, the transmission pattern candidate extraction unit 209 acquires one or a plurality of candidates of transmission pattern associated with the combination of the acquired detection results from the transmission pattern table storage unit 208. Then, the transmission pattern candidate extraction unit 209 notifies the throughput estimation unit 210 and the transmission pattern determination unit 211 of the acquired candidates of transmission pattern.

The throughput estimation unit 210 calculates estimation value of downlink throughput of each UE that is connected to the cell of the base station 200 for each candidate of transmission pattern notified from the transmission pattern candidate extraction unit 209 based on the quality information outputted from the UE quality information acquisition unit 207. Then, the throughput estimation unit 210 outputs the calculated estimation values of the throughput to the transmission pattern determination unit 211. The calculation of the estimation value of the throughput by the throughput estimation unit 210 will be described later.

The transmission pattern determination unit 211 determines a transmission pattern used to transmit a signal to UE from among the candidates of transmission pattern notified from the transmission pattern candidate extraction unit 209. For example, the transmission pattern determination unit 211 determines a transmission pattern whose estimation value of throughput notified from the throughput estimation unit 210 is the greatest among the notified candidates of transmission pattern to be the transmission pattern used to transmit a signal to the UE. The transmission pattern determination unit 211 notifies the UE scheduler 212 of the determined transmission pattern.

The UE scheduler 212 performs scheduling to assign a wireless resource to the UE so that a frequency band indicated by the transmission pattern notified from the transmission pattern determination unit 211 is used. The wireless resource includes, for example, a frequency resource and a time resource. The UE scheduler 212 outputs the result of the scheduling to the transmission signal creation unit 213.

The transmission signal creation unit 213 creates a signal to be transmitted to the UE based on the result of the scheduling outputted from the UE scheduler 212. Then, the transmission signal creation unit 213 outputs the created signal to the transmitter 214. The transmitter 214 wirelessly transmits the signal outputted from the transmission signal creation unit 213 to the UE through the transmission antenna 215.

FIG. 2C is a diagram illustrating an example of a hardware configuration of the base station. As illustrated in FIG. 2C, the received signal processing unit 203, the victim UE detection unit 204, the adjacent HeNB detection unit 205, the low quality UE detection unit 206, the UE quality information acquisition unit 207, and the transmission pattern candidate extraction unit 209 can be realized by a digital circuit 231. Further, the throughput estimation unit 210, the transmission pattern determination unit 211, the UE scheduler 212, and the transmission signal creation unit 213 can be realized by the digital circuit 231.

For the digital circuit 231, for example, a digital signal processor (DSP), a field programmable gate array (FPGA), or the like can be used. In this case, for example, the receiver 202 includes an analog/digital converter (ADC) that converts an analog signal outputted from the receiving antenna 201 into a digital signal and outputs the digital signal to the digital circuit 231. Further, for example, the transmitter 214 includes an digital/analog converter (DAC) that converts a digital signal outputted from the digital circuit 231 into an analog signal and outputs the analog signal to the transmission antenna 215.

The transmission pattern table storage unit 208 illustrated in FIGS. 2A and 2B can be realized by a memory 232. For the memory 232, for example, a non-volatile memory such as a magnetic disk and a flash memory can be used.

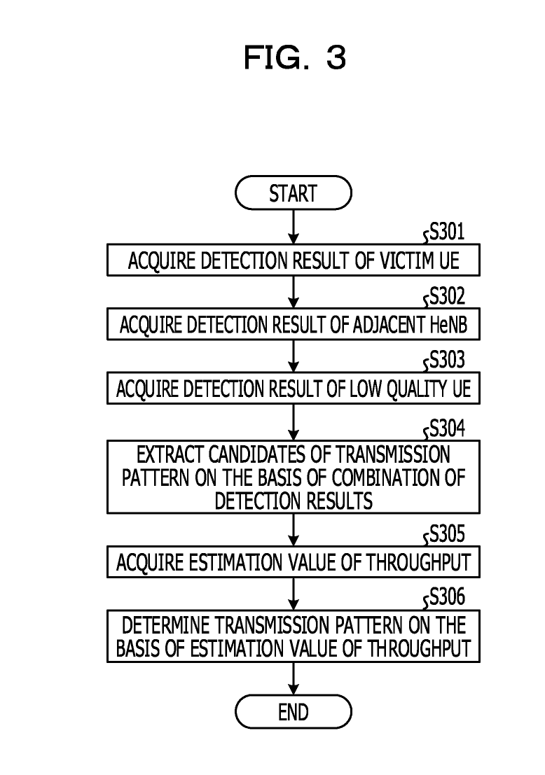

FIG. 3 is a flowchart illustrating an example of an operation of the transmission pattern candidate extraction unit and the transmission pattern determination unit. For example, the transmission pattern candidate extraction unit 209 and the transmission pattern determination unit 211 of the base station 200 according to the first embodiment repeatedly perform the steps described below.

First, the transmission pattern candidate extraction unit 209 acquires the detection result of the victim UE from the victim UE detection unit 204 (step S301). Further, the transmission pattern candidate extraction unit 209 acquires the detection result of the adjacent HeNB from the adjacent HeNB detection unit 205 (step S302). Further, the transmission pattern candidate extraction unit 209 acquires the detection result of the low quality UE from the low quality UE detection unit 206 (step S303). The order of the steps S301 to S303 can be changed.

Next, the transmission pattern candidate extraction unit 209 extracts candidates of the transmission pattern based on a combination of the detection results acquired by the steps S301 to S303 (step S304). Next, the transmission pattern determination unit 211 acquires an estimation value of the throughput from the throughput estimation unit 210 for each candidate of the transmission pattern extracted by the step S304 (step S305).

Next, the transmission pattern determination unit 211 determines the transmission pattern from among the candidates extracted by the step S304 based on the estimation value of the throughput acquired by the step S305 (step S306), and completes the series of operations.

By the steps described above, it is possible to extract candidates of the transmission pattern based on the combination of the detection results of the victim UE, the adjacent HeNB, and the low quality UE and select a transmission pattern whose throughput is high from among the extracted candidates.

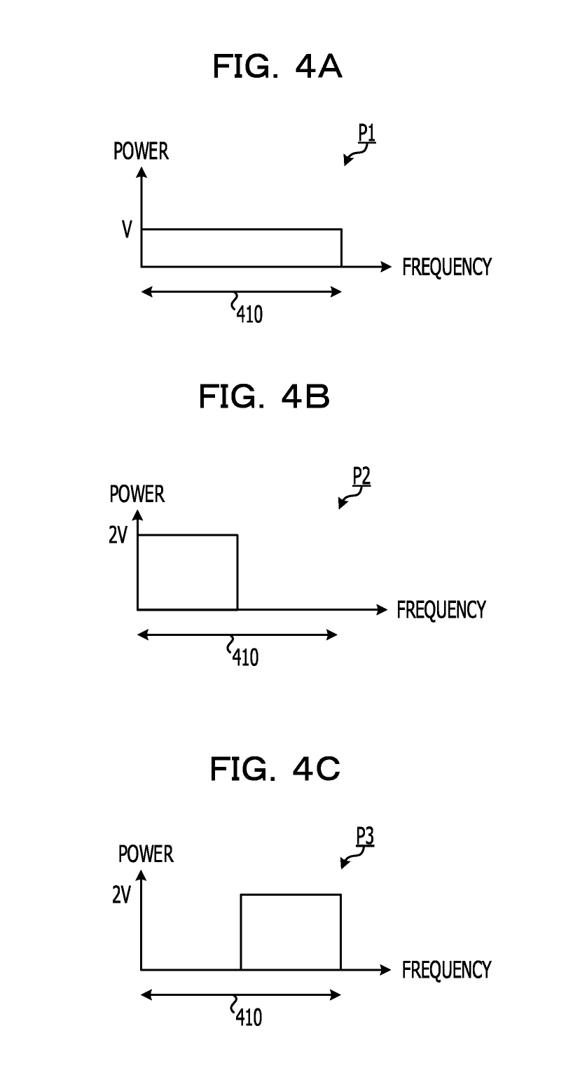

FIGS. 4A to 4C are diagrams illustrating an example of a candidate of the transmission pattern. Transmission patterns P1, P2, and P3 illustrated in FIGS. 4A to 4C represent a transmission pattern included in the transmission pattern table stored in the transmission pattern table storage unit 208. In the patterns P1, P2, and P3, the horizontal axis represents the frequency of a downlink signal and the vertical axis represents electric power of the downlink signal. A common frequency band 410 represents a frequency band that can be commonly used in downlink communication of the first base station 110 and the second base station 120.

The transmission pattern P1 illustrated in FIG. 4A is a transmission pattern which uses the entire band of the common frequency band 410 and transmits a signal by using a given power density (power V).

The transmission pattern P2 illustrated in FIG. 4B is a transmission pattern which uses the lower half of the common frequency band 410 and transmits a signal by using a power density (power 2V) twice that of the transmission pattern P1. Therefore, in the transmission pattern P2, the band width is ½ of that of the transmission pattern P1 and the power density is two times that of the transmission pattern P1, so that the product of the power density and the band width is the same as that of the transmission pattern P1.

The transmission pattern P3 illustrated in FIG. 4C is a transmission pattern which uses the upper half of the common frequency band 410 and transmits a signal by using a power density (power 2V) twice that of the transmission pattern P1. Therefore, in the transmission pattern P3, the band width is ½ of that of the transmission pattern P1 and the power density is two times that of the transmission pattern P1, so that the product of the power density and the band width is the same as that of the transmission pattern P1.

In this way, in the transmission patterns P2 and P3 that use a part of the common frequency band 410, the power density is greater than that of the transmission pattern P1 that uses the entire band of the common frequency band 410. Thereby, when a part of the common frequency band 410 is used, it is possible to wirelessly transmit a signal by using a power density greater than that used when the entire band of the common frequency band 410 is used. Thereby, it is possible to suppress degradation of the throughput when only a part of the common frequency band 410 is used.

Calculation of Estimation Value of Throughput

The calculation of the estimation values of the throughput of the transmission patterns P1, P2, and P3 by the throughput estimation unit 210 will be described. For example, it is assumed that CQIs of the lower frequency side of UE#i (i=1, 2, 3, and so on) are CQI_L[i] and CQIs of the upper frequency side of UE#i are CQI_H[i]. In this case, the estimation values of the throughput of the UE#i T_{P1}[i] to T_{P2}[i] when the patterns P1, P2, and P3 are used can be calculated by, for example, the formulas (I) below.

T_{P1}[i]=log₂(1+f(CQI_{—}L[i]))

+log₂(1+f(CQI_{—}H[i]))

T_{P2}[i]=log₂(1+f(CQI_{—}L[i]))

T_{P3}[i]=log₂(1+f(CQI_{—}H[i])) (1)

In the above formulas (I), Shannon's channel capacity formula, C=log₂(1+SINR) is used. Further, f(CQI) is a conversion formula from CQI to a signal to interference and noise ratio (SINR).

The throughput estimation unit 210 calculates the estimation values T_{P1}[i] to T_{P2}[i] of the throughput for each UE#i (i=1, 2, 3, and so on) of the base station 200. Then, throughput estimation unit 210 calculates an average value of the estimation values of the throughput for each of the patterns P1, P2, and P3 and outputs the calculation results to the transmission pattern determination unit 211. However, throughput estimation unit 210 may calculate not only the average value of the estimation values of the throughput, but also other indexes based on the estimation values of the throughput such as the minimum value and the logarithmic mean of the estimation values of the throughput.

In this way, it is possible to calculate an estimated throughput for each frequency band by using CQI for each frequency band transmitted by UE, so that it is possible to calculate the throughput of each user for each transmission pattern including the increase of the power density.

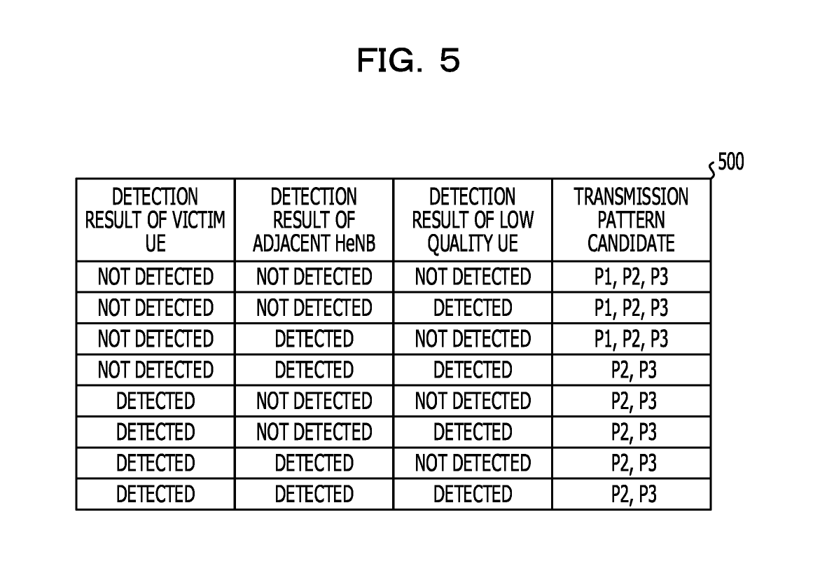

FIG. 5 is a diagram illustrating an example of the transmission pattern table. The transmission pattern table 500 illustrated in FIG. 5 is an example of the transmission pattern table stored in the transmission pattern table storage unit 208. In the transmission pattern table 500, “DETECTED” means that an object is detected and “NOT DETECTED” means that an object is not detected.

When Victim UE is Detected

For example, when a victim UE is detected, it is desirable to secure a frequency band in which interference is small in order to help the victim UE. Therefore, in the transmission pattern table 500, records where the detection result of the victim UE is “DETECTED” are associated with the transmission patterns P2 and P3 whose frequency band is halved. In this case, the base station 200 selects a transmission pattern by which the throughput is the highest from the transmission patterns P2 and P3.

When Both Low Quality UE and Adjacent HeNB are Detected

When both a low quality UE and an adjacent HeNB are detected, it is desirable to limit the frequency band of the adjacent HeNB. Therefore, in the transmission pattern table 500, records where the detection results of the low quality UE and the adjacent HeNB are “DETECTED” are associated with the transmission patterns P2 and P3 whose frequency band is halved. In this case, the base station 200 selects a transmission pattern by which the throughput is the highest from the transmission patterns P2 and P3.

Other Cases

In the transmission pattern table 500, records where the detection result of the victim UE is “NOT DETECTED” and the detection result of at least either one of the low quality UE and the adjacent HeNB is “NOT DETECTED” are associated with the transmission patterns P1, P2, and P3 including the transmission pattern P1. In this case, the base station 200 selects a transmission pattern by which the throughput is the highest from the transmission patterns P1, P2, and P3.

When the transmission patterns P2 and P3 are selected in an adjacent cell, one-half of the entire frequency band is not used in the adjacent cell. Therefore, it is highly probable that the estimation value of the throughput of either one of the transmission patterns P2 and P3 is the greatest among the candidate transmission patterns P1, P2, and P3. As a result, it is possible to improve the throughput by automatically selecting different frequency bands between the base stations 200 adjacent to each other.

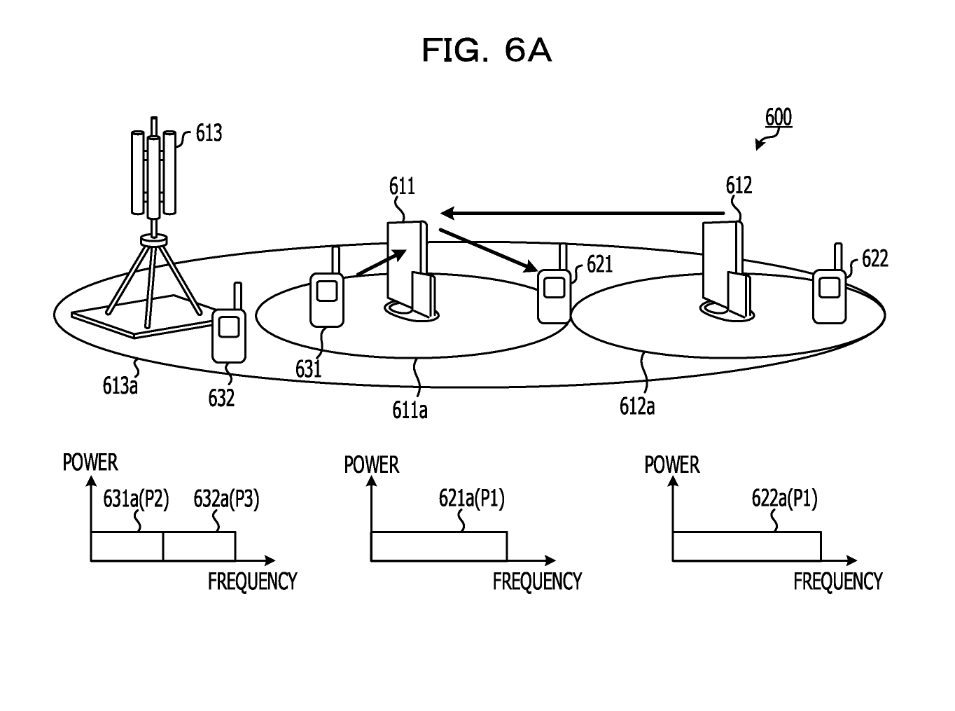

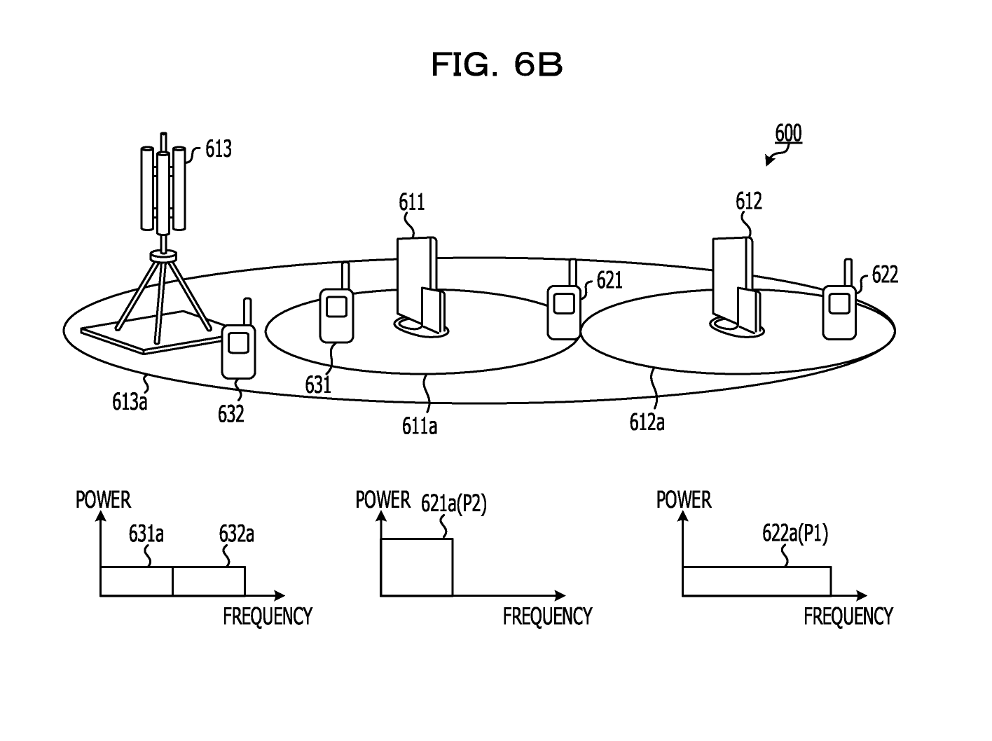

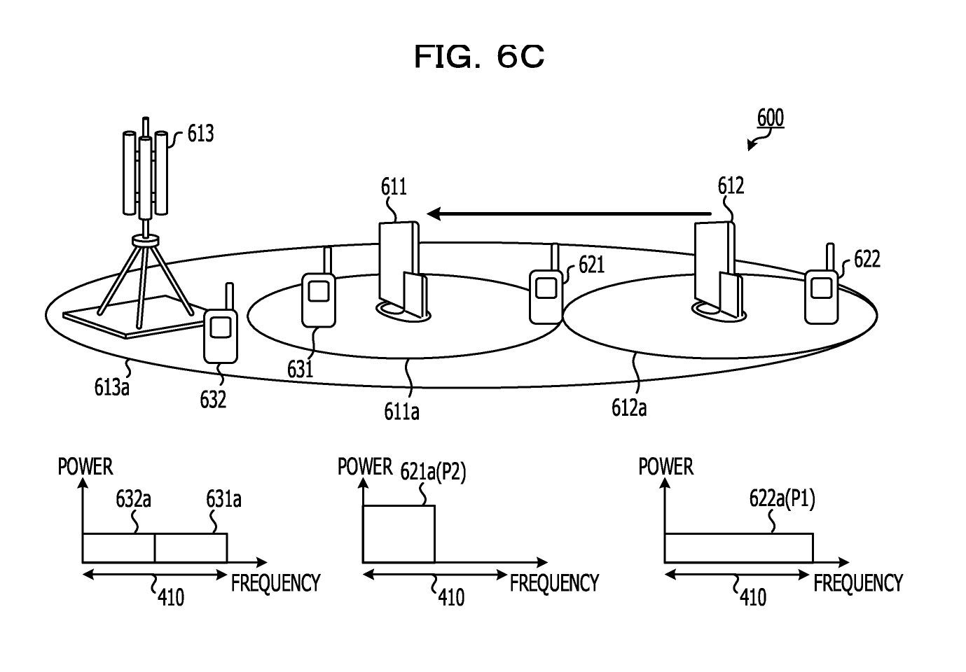

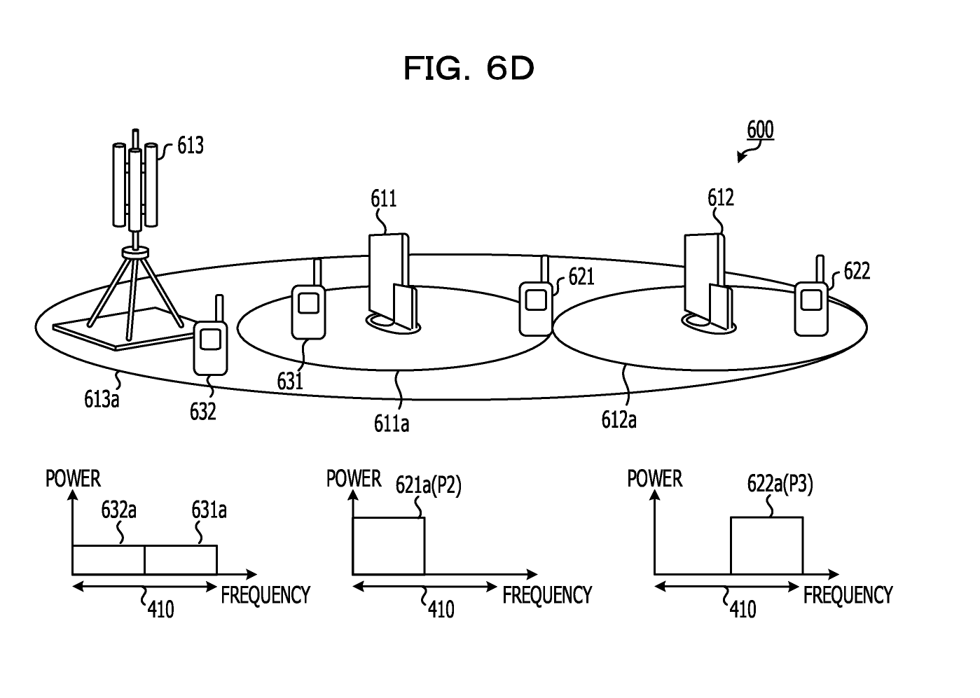

FIGS. 6A to 6D are diagrams illustrating an example of an operation of a communication system. The communication system 600 illustrated in FIGS. 6A to 6D includes HeNBs 611 and 612, a MeNB 613, HUEs 621 and 622, and MUEs 631 and 632. The HeNB 611 corresponds to, for example, the first base station 110 illustrated in FIG. 1. The HeNB 612 corresponds to, for example, the second base station 120 illustrated in FIG. 1. The HUE 621 corresponds to, for example, the wireless terminal 102 illustrated in FIG. 1. The MUE 631 corresponds to, for example, the wireless terminal 104 illustrated in FIG. 1.

The cell 611a of the HeNB 611 and the cell 612a of the HeNB 612 are adjacent to each other. Therefore, the HeNB 611 detects the HeNB 612 as an adjacent HeNB. Also, the HeNB 612 detects the HeNB 611 as an adjacent HeNB.

Although the HUE 621 (Home UE) is connected to the HeNB 611, the HUE 621 is away from the HeNB 611 and further the HUE 621 is close to the HeNB 612 to receive interference from the HeNB 612, so that the HUE 621 is a low quality terminal whose quality of communication with the HeNB 611 is low. Therefore, the HeNB 611 detects the HUE 621 as a low quality UE.

The HUE 622 is connected to the HeNB 612.

The Macro UEs (MUEs) 631 and 632 are located in a range of the cell 613a of the Macro eNB (MeNB) 613 and connected to the MeNB 613. Although the MUE 631 is not connected to the HeNB 611, the MUE 631 is close to the HeNB 611, so that the MUE 631 is a victim UE that receives interference from the HeNB 611. Therefore, the HeNB 611 detects the MUE 631 as a victim UE.

The transmission pattern 621a represents a frequency band of a downlink signal transmitted from the HeNB 611 to the HUE 621. In a state illustrated in FIG. 6A, the HeNB 611 selects the transmission pattern P1 as the transmission pattern 621a. The transmission pattern 622a represents a frequency band of a downlink signal transmitted from the HeNB 612 to the HUE 622. In the state illustrated in FIG. 6A, the HeNB 612 selects the transmission pattern P1 as the transmission pattern 622a.

The transmission pattern 631a represents a frequency band of a downlink signal transmitted from the HeNB 613 to the HUE 631. In the state illustrated in FIG. 6A, the MeNB 613 selects the lower side of the frequency band as the transmission pattern 631a. The transmission pattern 632a represents a frequency band of a downlink signal transmitted from the MeNB 613 to the MUE 632. In the state illustrated in FIG. 6A, the MeNB 613 selects the upper side of the frequency band as the transmission pattern 632a.

The HeNB 611 detects the adjacent HeNB (HeNB 612), the victim UE (MUE 631), and the low quality UE (HUE 621), so that the HeNB 611 selects a pattern where the throughput is high from the patterns P2 and P3 in which the frequency band is halved. Here, as illustrated in FIG. 6B, it is assumed that the HeNB 611 selects the pattern P2 that uses the lower side of the frequency band.

Thereby, the interference to the MUE 631 from the HeNB 611 decreases in the upper side of the frequency band, so that as illustrated in FIG. 6C, the MeNB 613 assigns the upper side of the frequency band to the MUE 631 as a result of scheduling. On the other hand, the interference to the MUE 632 from the HeNB 611 is small, the MeNB 613 assigns the lower side of the frequency band, which is the same as that selected by the HeNB 611, to the MUE 632 as a result of scheduling.

Since the HeNB 612 detects only the adjacent HeNB (HeNB 611), the HeNB 612 selects any one of the patterns P1, P2, and P3. Here, the interference from the HeNB 611 decreases in the upper side of the frequency band, so that the throughput is the greatest by the pattern P3 that uses only the upper side of the frequency band. Therefore, as illustrated in FIG. 6D, the HeNB 612 selects the pattern P3 that uses the upper side of the frequency band.

In this way, the HeNBs 611 and 612 can autonomously performs interference control in the communication system 600 in which a macro base station (MeNB 613) and femto base stations (HeNBs 611 and 612) coexist. Thereby, it is possible to help the victim UE (MUE 631) and improve the throughput of the femto users (HUEs 621 and 622), so that it is possible to improve the throughput of the entire communication system 600.

As described above, according to the first embodiment, each femto base station adjacent to each other can autonomously control the transmission frequency band according to a combination of the detection results of a victim UE affected by the femto base station, a low quality UE in the cell of the femto base station, and an adjacent femto base station. Thereby, it is possible to improve the throughput of both the victim UE and the low quality UE and improve the throughput of the entire system.

### Second Embodiment

Differences of the base station 200 according to a second embodiment from the base station 200 according to the first embodiment will be described. For example, in LTE, Synchronization Signal (SS) is transmitted at a given timing twice per 10 [ms] in frequency bands of six resource blocks (RBs) at the center of the common frequency band 410. The SS includes, for example, synchronization information.

Further, for example, in LTE, Physical Broadcast Channel (PBCH) is transmitted at a given timing once per 10 [ms] in frequency bands of six resource blocks at the center of the common frequency band 410. The PBCH includes, for example, system information. The SS and PBCH are channels which UE receives when starting communication.

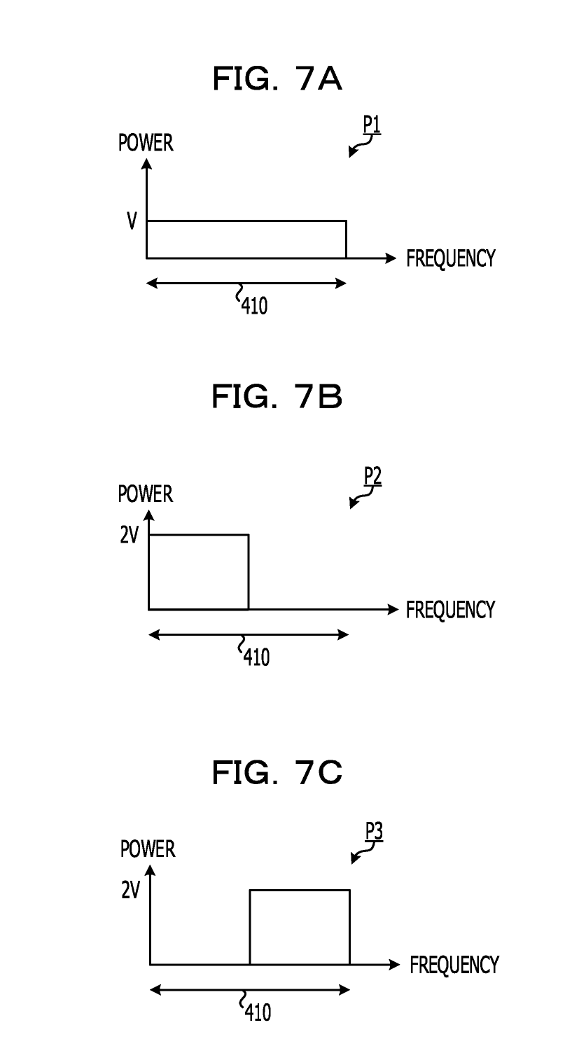

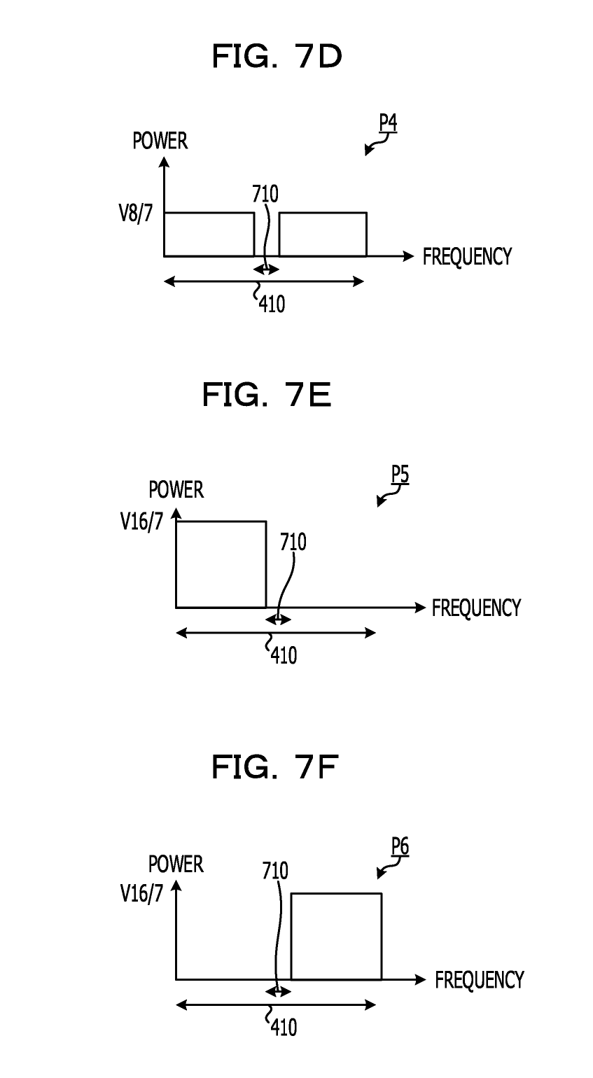

FIGS. 7A to 7F are diagrams illustrating an example of the transmission pattern. As illustrated in FIGS. 7A to 7F, in the base station 200 according to the second embodiment, the transmission patterns P1 to P6 are defined. In the transmission patterns P1 to P6 illustrated in FIGS. 7A to 7F, the horizontal axis represents the frequency of a downlink signal and the vertical axis represents electric power of the downlink signal.

The central frequency band 710 indicates a frequency band including a frequency band in which control signals such as the SS and the PBCH are transmitted in the common frequency band 410. For example, the central frequency band 710 is a frequency band occupying the central ⅛ of the common frequency band 410. The transmission patterns P1, P2, and P3 illustrated in FIGS. 7A to 7C are the same as, for example, the transmission patterns P1, P2, and P3 illustrated in FIGS. 4A to 4C.

The transmission pattern P4 illustrated in FIG. 7D is a transmission pattern which uses the common frequency band 410 except for the central frequency band 710 and transmits a signal by using a power density (power V 8/7) 8/7 times that of the transmission pattern P1. Therefore, in the transmission pattern P4, the band width is ⅞ of that of the transmission pattern P1 and the power density is 8/7 times that of the transmission pattern P1, so that the product of the power density and the band width is the same as that of the transmission pattern P1.

The transmission pattern P5 illustrated in FIG. 7E is a transmission pattern which uses the lower half of the common frequency band 410 except for the central frequency band 710 and transmits a signal by using a power density (power V 16/7) 16/7 times that of the transmission pattern P1. Therefore, in the transmission pattern P5, the band width is 7/16 of that of the transmission pattern P1 and the power density is 16/7 times that of the transmission pattern P1, so that the product of the power density and the band width is the same as that of the transmission pattern P1.

The transmission pattern P6 illustrated in FIG. 7F is a transmission pattern which uses the upper half of the common frequency band 410 except for the central frequency band 710 and transmits a signal by using a power density (power V 16/7) 16/7 times that of the transmission pattern P1. Therefore, in the transmission pattern P6, the band width is 7/16 of that of the transmission pattern P1 and the power density is 16/7 times that of the transmission pattern P1, so that the product of the power density and the band width is the same as that of the transmission pattern P1.

In this way, in the transmission patterns P4, P5, and P6 illustrated in FIGS. 7D to 7F, transmission of a downlink signal to UE by the central frequency band 710 in which control signals such as the SS and the PBCH are transmitted is stopped. Thereby, it is possible to reduce interference to the control signals such as the SS and the PBCH.

Further, in the transmission patterns P4, P5, and P6 that use a part of the common frequency band 410, the power density is greater than that of the transmission pattern P1 that uses the entire band of the common frequency band 410. Thereby, when a part of the common frequency band 410 is used, it is possible to wirelessly transmit a signal by using a power density greater than that used when the entire band of the common frequency band 410 is used. Thereby, it is possible to suppress degradation of the throughput when only a part of the common frequency band 410 is used.

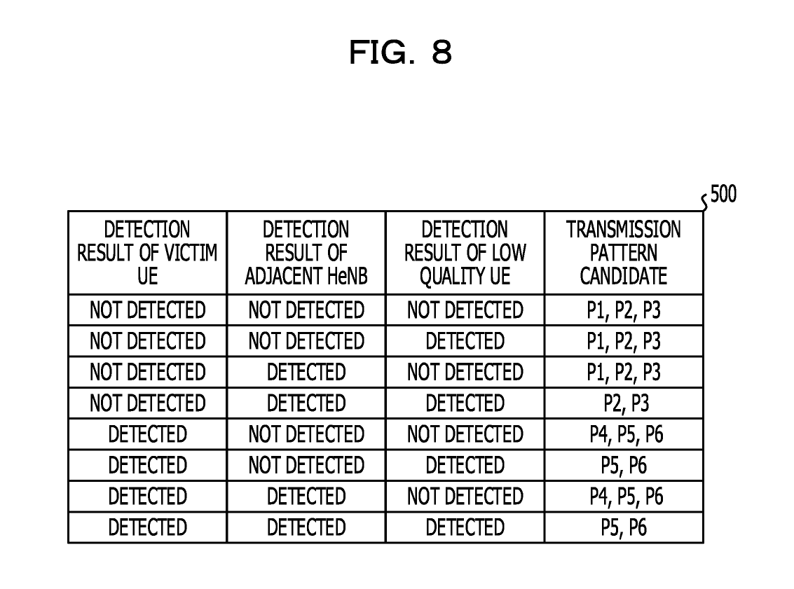

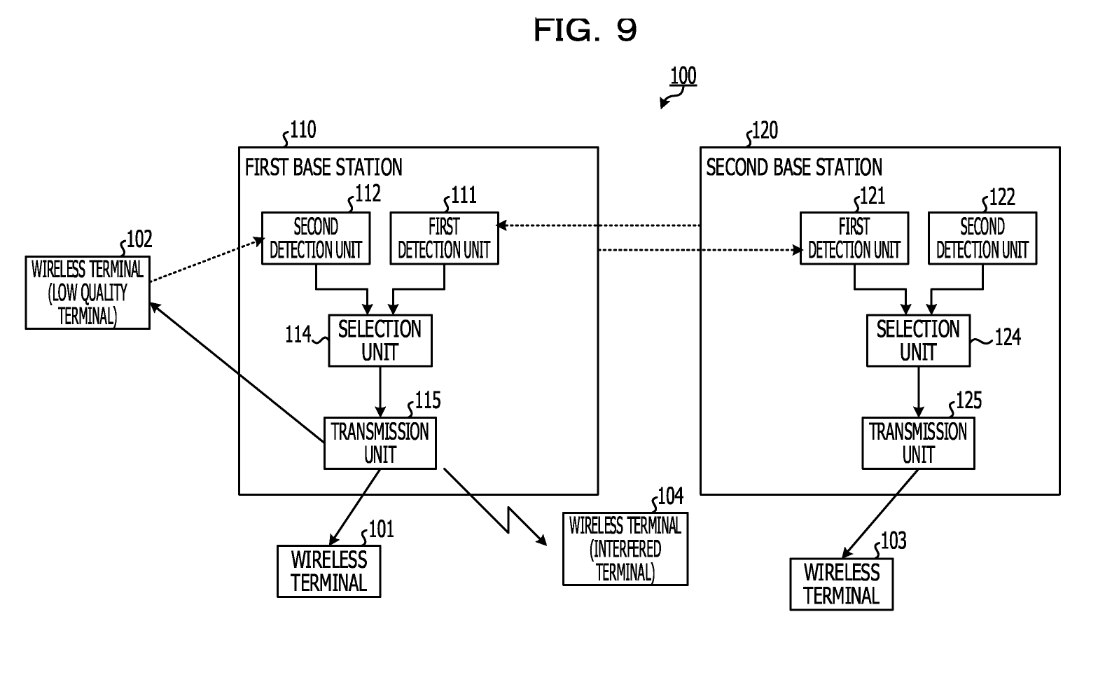

FIG. 8 is a diagram illustrating an example of the transmission pattern table. The transmission pattern table 500 illustrated in FIG. 8 is an example of the transmission pattern table stored in the transmission pattern table storage unit 208 according to the second embodiment.

For example, when a victim UE is detected, to help the victim UE, it is desirable to secure a frequency band in which the control signals such as the SS and the PBCH are transmitted. Therefore, in the transmission pattern table 500 illustrated in FIG. 8, records where the detection result of the victim UE is “DETECTED” are associated with transmission patterns included in the transmission patterns P4, P5, and P6 which are obtained by removing the central frequency band 710 from the common frequency band 410.

As described above, according to the second embodiment, a plurality of candidate frequency bands associated with a combination in a case in which an interfered terminal is detected are frequency bands, from which given frequency bands in which given control signals are transmitted by another communication apparatus is removed. Thereby, it is possible to reduce interference to the control signals.

Further, the signal transmitting timing may be synchronized among the MeNB 613 and the HeNB 611 and 612, and transmission patterns may be transmitted for every time period. Thereby, it is possible to avoid that a transmission pattern which generates interference to the control signals such as the SS and the PBCH continues, so that it is possible to efficiently avoid the interference to the control signals such as the SS and the PBCH.

### Third Embodiment

Differences of the base station 200 according to a third embodiment from the base station 200 according to the first embodiment will be described.

FIG. 9 is a diagram illustrating an example of a communication system according to the third embodiment. In FIG. 9, the same components as those illustrated in FIG. 1 are given the same reference numerals and the description thereof will be omitted. As illustrated in FIG. 9, the communication system 100 according to the third embodiment may have a configuration obtained by removing the third detection unit 113 of the first base station 110 and the third detection unit 123 of the second base station 120 from the configuration illustrated in FIG. 1.

The selection unit 114 of the first base station 110 selects a frequency band used for the first base station 110 to transmit a downlink signal from the common frequency band based on a combination of the detection results outputted from the first detection unit 111 and the second detection unit 112.

The selection unit 124 of the second base station 120 selects a frequency band used for the second base station 120 to transmit a downlink signal from the common frequency band based on a combination of the detection results outputted from the first detection unit 121 and the second detection unit 122.

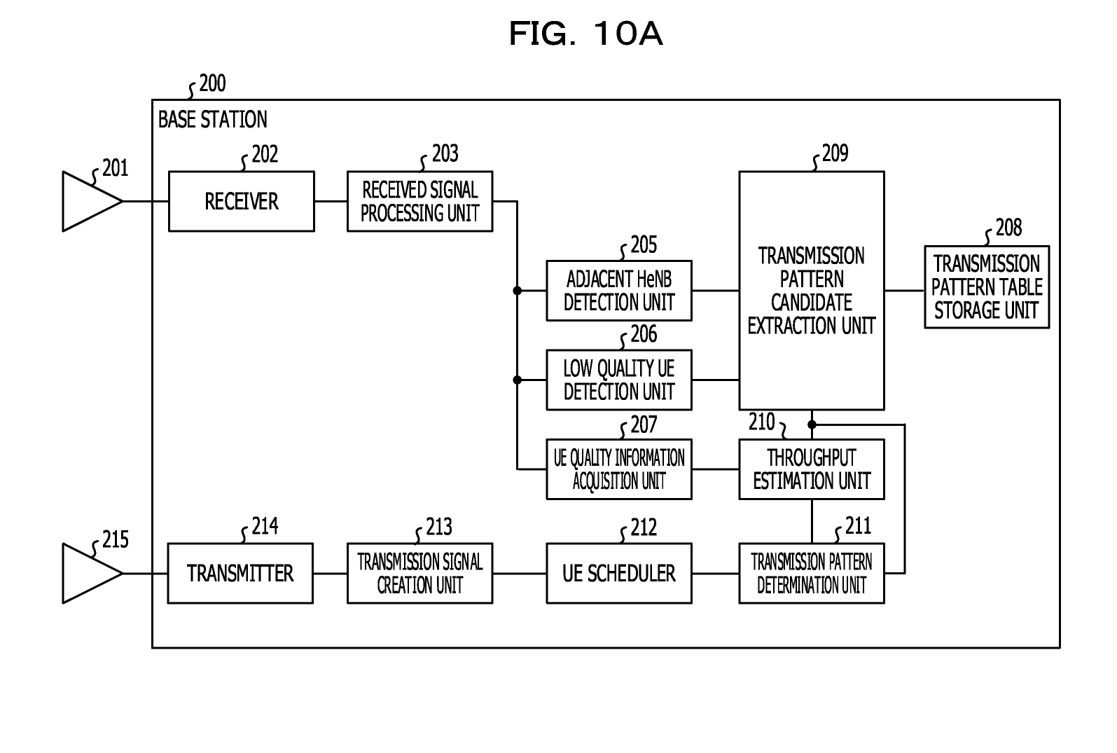

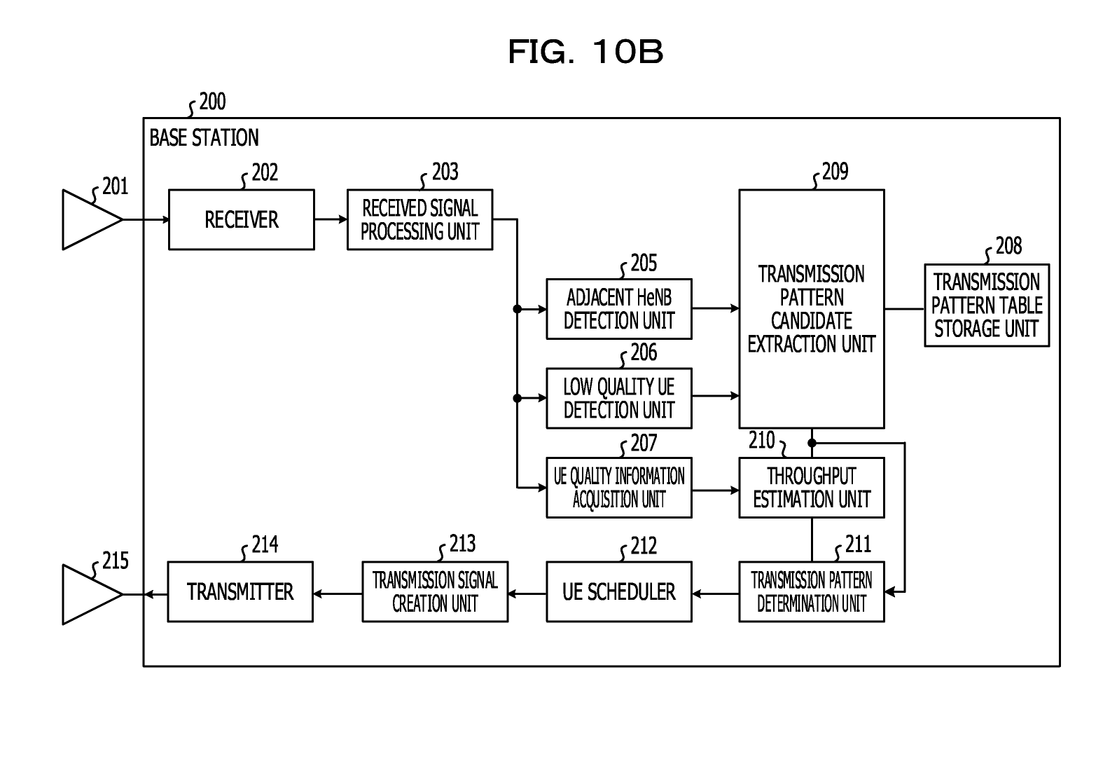

FIG. 10A is a diagram illustrating an example of the base station. FIG. 10B is a diagram illustrating an example of a signal flow in the base station illustrated in FIG. 10A. In FIGS. 10A and 10B, the same components as those illustrated in FIGS. 2A and 2B are given the same reference numerals and the description thereof will be omitted. As illustrated in FIGS. 10A and 10B, the base station 200 according to the third embodiment may have a configuration obtained by removing the victim UE detection unit 204 from the configuration of the base station 200 illustrated in FIGS. 2A and 2B.

The transmission pattern table storage unit 208 stores a transmission pattern table that associates a combination of the detection results of the adjacent HeNB detection unit 205 and the low quality UE detection unit 206 with candidates of transmission pattern. The transmission pattern candidate extraction unit 209 acquires one or a plurality of candidates of transmission pattern associated with the combination of the detection results of the adjacent HeNB detection unit 205 and the low quality UE detection unit 206 from the transmission pattern table storage unit 208.

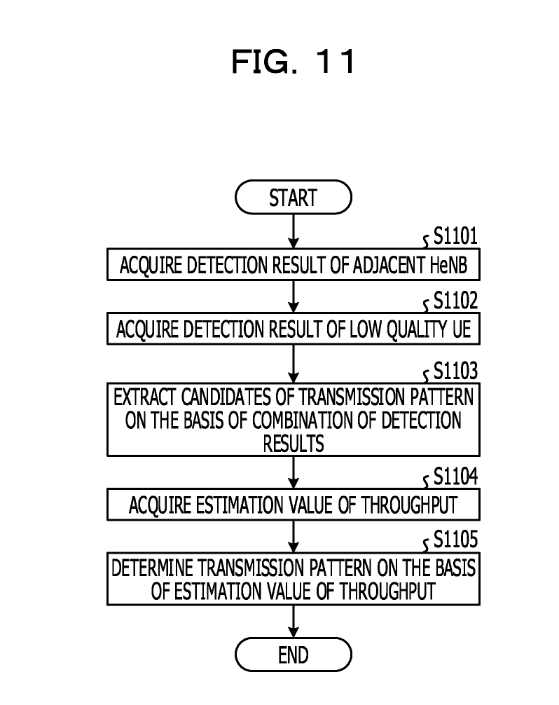

FIG. 11 is a flowchart illustrating an example of an operation of the transmission pattern candidate extraction unit and the transmission pattern determination unit. For example, the transmission pattern candidate extraction unit 209 and the transmission pattern determination unit 211 of the base station 200 according to the third embodiment repeatedly perform the steps described below.

First, the transmission pattern candidate extraction unit 209 acquires the detection result of the adjacent HeNB from the adjacent HeNB detection unit 205 (step S1101). Further, the transmission pattern candidate extraction unit 209 acquires the detection result of the low quality UE from the low quality UE detection unit 206 (step S1102). The order of the steps S1101 and S1102 can be changed.

Next, the transmission pattern candidate extraction unit 209 extracts candidates of the transmission pattern based on a combination of the detection results acquired by the steps S1101 to S1102 (step S1103). Next, the transmission pattern determination unit 211 acquires an estimation value of the throughput from the throughput estimation unit 210 for each candidate of the transmission pattern extracted by the step S1103 (step S1104).

Next, the transmission pattern determination unit 211 determines the transmission pattern from among the candidates extracted by the step S1103 based on the estimation value of the throughput acquired by the step S1104 (step S1105), and completes the series of operations.

By the steps described above, it is possible to extract candidates of the transmission pattern based on the combination of the detection results of the adjacent HeNB and the low quality UE and select a transmission pattern whose throughput is high from among the extracted candidates.

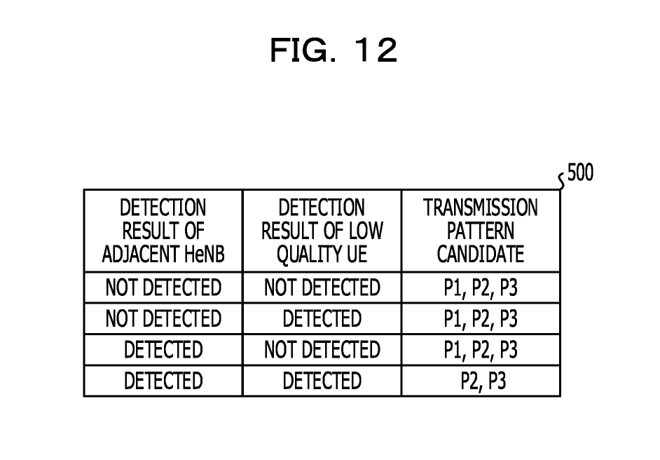

FIG. 12 is a diagram illustrating an example of the transmission pattern table. The transmission pattern table 500 illustrated in FIG. 12 is an example of the transmission pattern table stored in the transmission pattern table storage unit 208 according to the third embodiment.

As illustrated in FIG. 12, in the transmission pattern table 500 stored in the transmission pattern table storage unit 208 according to the third embodiment, a combination of the detection result of the adjacent HeNB and the detection result of the low quality UE is associated with candidates of transmission pattern.

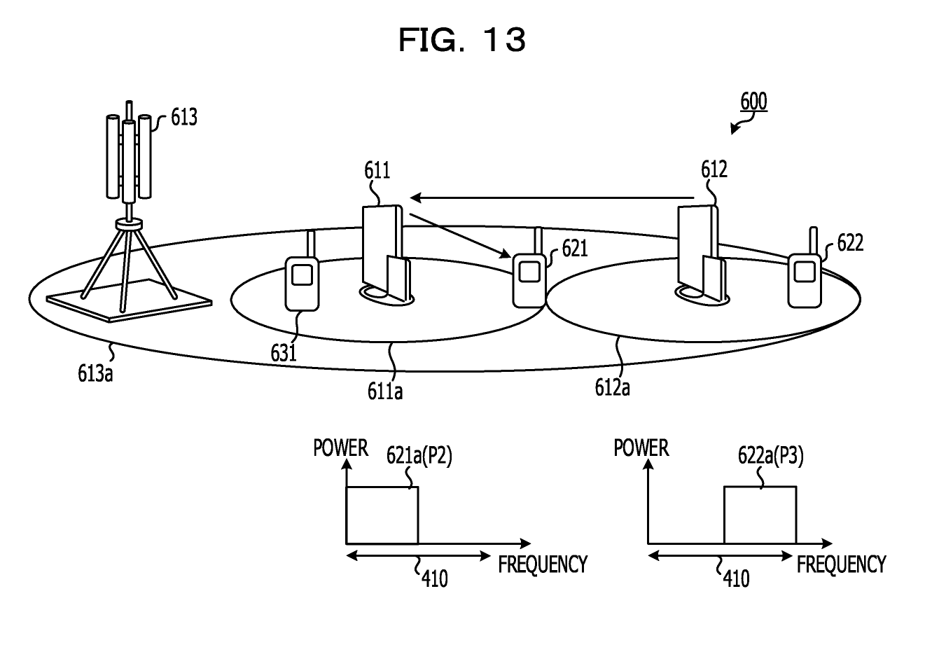

FIG. 13 is a diagram illustrating an example of an operation of the communication system. In FIG. 13, the same components as those illustrated in FIG. 6D are given the same reference numerals and the description thereof will be omitted. The operation of the HeNBs 611 and 612 according to the third embodiment will be described, in which the detection of the victim UE (MUE 631) is omitted in a situation similar to the situation illustrated in FIG. 6A.

The HeNB 611 detects the adjacent HeNB (HeNB 612) and the low quality UE (HUE 621), so that the HeNB 611 selects a pattern where the throughput is high from the patterns P2 and P3 in which the frequency band is halved. Here, as illustrated in FIG. 13, it is assumed that the HeNB 611 selects the pattern P2 that uses the lower side of the frequency band.

On the other hand, the HeNB 612 detects only the adjacent HeNB (HeNB 611), the HeNB 612 selects any one of the patterns P1, P2, and P3. Here, the interference from the HeNB 611 decreases in the upper side of the frequency band, so that the throughput is the greatest by the pattern P3 that uses only the upper side of the frequency band. Therefore, as illustrated in FIG. 13, the HeNB 612 selects the pattern P3 that uses the upper side of the frequency band.

In this way, also in the third embodiment in which the detection of the victim UE is omitted, the HeNBs 611 and 612 can autonomously performs interference control in the communication system 600 in which a macro base station (MeNB 613) and femto base stations (HeNBs 611 and 612) coexist. Thereby, it is possible to improve the throughput of the femto users (HUEs 621 and 622), so that the throughput of the entire communication system 600 can be improved.

### Modified Example of Transmission Pattern

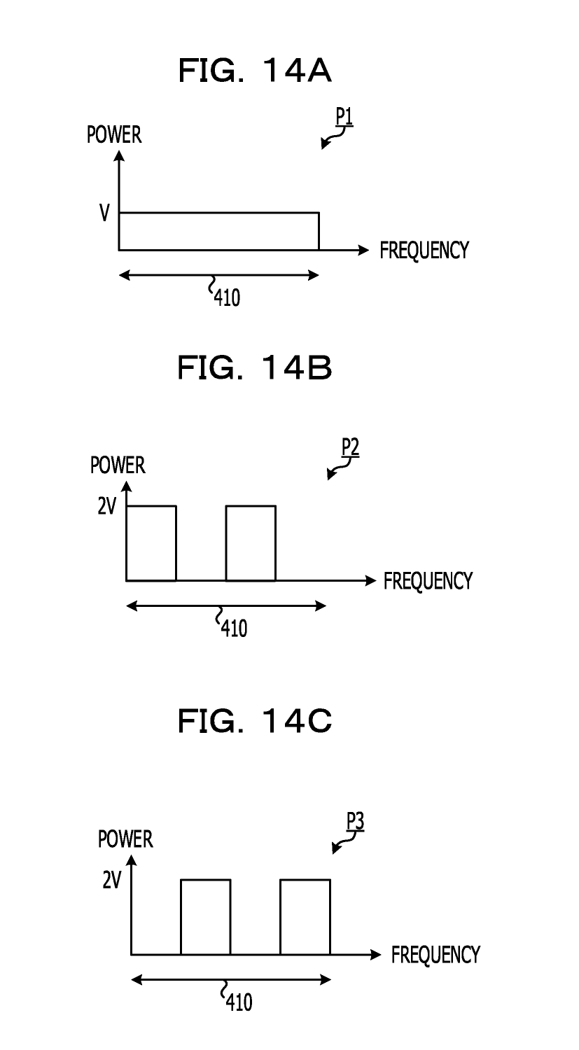

FIGS. 14A to 14C are diagrams illustrating a modified example of a candidate of the transmission pattern. In FIGS. 14A to 14C, the same portions as those illustrated in FIGS. 4A to 4C are given the same reference numerals and the description thereof will be omitted. As illustrated in FIGS. 14B and 14C, each of the transmission patterns P2 and P3 (candidates of the frequency band) may be a plurality of frequency bands which are not adjacent to each other. The frequency bands of the transmission pattern P2 and the frequency bands of the transmission pattern P3 do not overlap each other.

Thereby, for example, when the first base station 110 and the second base station 120 select the transmission patterns P2 and P3 respectively, it is possible to suppress interference to each other. Further, in each of the first base station 110 and the second base station 120, a plurality of frequency bands which do not overlap each other are used, so that it is possible to further improve the throughput by a frequency diversity effect.

In this way, each of the transmission patterns P2 and P3 which use a part of frequency bands of the common frequency band 410 among the transmission patterns P1, P2, and P3 includes a plurality of frequency bands which do not overlap each other, so that the throughput can be further improved.

As described above, according to the base station, the communication system, and the communication method, it is possible to improve the throughput.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus, comprising:
a processor configured to:
perform a first detection to detect another wireless communication apparatus that shares given frequency bands with the wireless communication apparatus and that causes interference with the wireless communication apparatus,
perform a second detection to detect a second wireless terminal that has communication quality lower than or equal to a given value from a first wireless terminal that communicates with the wireless communication apparatus, and
select a frequency band from the given frequency bands for communication with the first wireless terminal based on a combination of detection result of the first detection and the second detection; and
a transmitter coupled to the processor and configured to transmit a signal to the first wireless terminal using the selected frequency band.

2. The wireless communication apparatus of claim 1, wherein
the processor selects the frequency band
by extracting a plurality of candidate frequency bands based on correspondence information between the combination of the detection results and a plurality of candidate frequency bands included in the given frequency bands,
by calculating an estimated throughput between the wireless communication apparatus and the first wireless terminal for each of the extracted candidate frequency bands, and
by selecting the frequency band from the extracted candidate frequency bands based on the calculated estimated throughputs.

3. The wireless communication apparatus of claim 2, wherein
the processor selects the frequency band by extracting the plurality of candidate frequency bands each of which is a part of the given frequency bands, when the another wireless communication apparatus is detected by the first detection and the second wireless terminal is detected by the second detection.

4. The wireless communication apparatus of claim 3, wherein
the transmitter transmits, when the part of the given frequency bands is selected, the signal using a radio frequency (RF) power density greater than that of the entire given frequency band.

5. The wireless communication apparatus of claim 3, wherein
the part of the given frequency bands is a plurality of frequency bands that do not overlap each other.

6. The wireless communication apparatus of claim 1, wherein
the transmitter is further configured to transmit the signal in synchronization with transmission timing of a signal communicated between wireless communication apparatuses affected by interference caused by the wireless communication apparatus, and
the processor is further configured to change the selected frequency band for each time period.

7. The wireless communication apparatus of claim 1, wherein
the processor performs the first detection to detect the another wireless communication apparatus based on a signal transmitted from the another wireless communication apparatus.

8. The wireless communication apparatus of claim 1, wherein
the processor performs the second detection to detect the second wireless terminal based on communication quality between the wireless communication apparatus and the first wireless terminal, the communication quality being provided by the first wireless terminal.

9. The wireless communication apparatus of claim 1, wherein
the wireless communication apparatus generates a first cell on the given frequency bands, the another wireless communication apparatus generates a second cell on the given frequency bands, and the second cell causes interference with the first cell.

10. The wireless communication apparatus of claim 1, wherein
the processor is further configured to perform a third detection to detect a third wireless terminal that is not coupled to the wireless communication apparatus and that is affected by interference caused by the wireless communication apparatus, and
the processor selects the frequency band from the given frequency bands based on a combination of detection results of the first detection, the second detection, and the third detection.

11. The wireless communication apparatus of claim 10, wherein
the processor selects the frequency band by extracting the plurality of candidate frequency bands each of which is a part of the given frequency bands, when the third wireless terminal is detected by the third detection.

12. The wireless communication apparatus of claim 10, wherein
the processor selects the frequency band by extracting the plurality of candidate frequency bands from which a given frequency band used for transmission of a control signal by the another wireless communication apparatus is removed, when the third wireless terminal is detected by the third detection.

13. The wireless communication apparatus of claim 12, wherein the given frequency band used for transmission of the control signal is a central frequency band of the given frequency bands.

14. The wireless communication apparatus of claim 10, wherein
the processor is further configured to measure radio frequency (RF) power of an uplink signal transmitted from another wireless terminal coupled to the another wireless communication apparatus, and
the processor is performs the third detection to detect the third wireless terminal based on the measured RF power.

15. A wireless communication circuit, comprising:
a memory; and
a processor coupled to the memory and configured to:
perform a first detection to detect another wireless communication apparatus that shares given frequency bands with the wireless communication apparatus and that causes interference with the wireless communication apparatus,
perform a second detection to detect a second wireless terminal that has communication quality lower than or equal to a given value from a first wireless terminal that communicates with the wireless communication apparatus, and
select a frequency band from the given frequency bands for communication with the first wireless terminal based on a combination of detection result of the first detection and the second detection; and
a transmitter coupled to the processor and configured to transmit a signal to the first wireless terminal using the selected frequency band.

16. The wireless communication circuit of claim 15, wherein
the processor is further configured to perform a third detection to detect a third wireless terminal that is not coupled to the wireless communication apparatus and that is affected by interference caused by the wireless communication apparatus, and
the processor selects the frequency band from the given frequency bands based on a combination of detection results of the first detection, the second detection, and the third detection.

17. A wireless communication system, comprising:
a first wireless communication apparatus configured to perform communication using a given frequency bands;
a second wireless communication apparatus configured to perform communication using the given frequency bands and cause interference with the first wireless communication apparatus; and
one or more wireless terminals configured to communicate with at least one of the first and second wireless communication apparatuses,
wherein at least the first wireless communication apparatus is configured to:
perform a first detection to detect the second wireless communication apparatus,
perform a second detection to detect a second wireless terminal that has communication quality lower than or equal to a given value from a first wireless terminal that communicates with the first wireless communication apparatus, among the one or more wireless terminals, and
select a frequency band from the given frequency bands for communication with the first wireless terminal based on a combination of detection result of the first detection and the second detection, and
wherein the first wireless terminal is configured to receive a signal transmitted from the first wireless communication apparatus using the selected frequency bands.

18. The wireless communication system of claim 17, wherein
at least the first wireless communication apparatus is further configured to perform a third detection to detect a third wireless terminal that is not coupled to the first wireless communication apparatus and that is affected by interference caused by the wireless communication apparatus, among the one or more wireless terminals, and
at least the first wireless communication apparatus selects the frequency band from the given frequency bands based on a combination of detection results of the first detection, the second detection, and the third detection.

19. A wireless communication method, comprising:
performing a first detection to detect another wireless communication apparatus that shares given frequency bands with a wireless communication apparatus and that causes interference with the wireless communication apparatus;
performing a second detection to detect a second wireless terminal that has communication quality lower than or equal to a given value from a first wireless terminal that communicates with the wireless communication apparatus;
selecting, by a processor, a frequency band from the given frequency bands for communication with the first wireless terminal based on a combination of detection result of the first detection and the second detection; and
transmitting a signal to the first wireless terminal using the selected frequency band.

20. The wireless communication method of claim 19, further comprising:
performing a third detection to detect a third wireless terminal that is not coupled to the wireless communication apparatus and that is affected by interference caused by the wireless communication apparatus, wherein
the selecting includes selecting the frequency band from the given frequency bands based on a combination of detection results of the first detection, the second detection, and the third detection.
